(19) United States
(12) Patent Application Publication
(10) Pub. No.: US 2018/0108136 A1
(43) Pub. Date: Apr. 19, 2018

(54) METHOD OF LENGTH MEASUREMENT FOR 2D PHOTOGRAPHY

(71) Applicant: Ortery Technologies, Inc., New Taipei City (TW)

(72) Inventors: PENG-CHENG LAI, Los Altos, CA (US); Chun-Hsien CHIANG, Taipei City (TW)

(21) Appl. No.: 15/296,397

(22) Filed: Oct. 18, 2016

(51) Int. Cl. G06T 7/00; G06T 7/60; G06T 7/40

(52) U.S. Cl. CPC G06T 7/0067; G06T 7/602; G06T 2207/20144; G06T 7/408; G06T 7/0097

(57) ABSTRACT

A method of length measurement for 2d photography comprises the following steps. A reference object and a measuring object are respectively photographed to form a reference image and a measuring image, wherein the reference object has a geometrical shape capable of being represented by an area formula saved in a computer with a predetermined size. A background image is separated from the reference image and then the reference image is scanned to obtain a total number of pixels included therein, and a first number of pixels corresponding to a unit length is obtained based on the predetermined size and the area formula. An actual length between any two points of the measuring object image clicked on a screen of the computer can be obtained based on a ratio of a second number of pixels corresponding to the two points to the first number of pixels.

### FIELD OF THE INVENTION

The present invention relates to a method of length measurement for 2d photography, and more particularly to a method of length measurement for 2d photography by calculating an area of a geometrical shape of a reference object with a predetermined size.

### DESCRIPTION OF THE RELATED ART

Generally, a consumer is difficult to confirm the real size of the product according to the image on the website since the image is unable to be measured directly, and thus possibly results in shopping hesitation, shopping disputation, goods returning and refunding, or goods replacement. For this consideration, one general approach is retouching dimensions on the image, however, it decreases not only the visual perception but also the usage of background. Another approach is taking a picture of the photographed object accompanied with a ruler, so as to enable viewers to know the size of the photographed object by seeing the photographed object together with the scale of the ruler. However, such two approaches are only suitable for providing the main dimensions of the product, such as the total length and the total height, and the detail dimensions of the product, such as the dimensions of a pattern, a pocket or a sleeve of a clothes, can only be roughly calculated by the viewer based on a visual proportion of the desired part to the dimensioned part. Moreover, with regard to a photographed object with an uneven surface, the distances from the camera to different part of the uneven surface are not always the same as the distance from the camera to the ruler, and thus it is possible to obtain an inaccurate calculation result.

One more approach is taking a picture of the photographed object accompanied with a reference object, wherein the dimension of the reference object can be manually measured by using a ruler or an optical instrument and then further keyed in to present on the website for reference. However, not only the manual measuring and keying in may result in incorrect dimensions, but also the detail dimensions of the product can only be roughly calculated by the viewer based on the visual proportion of the desired part to the dimensioned part. In contrast, the following embodiments provide various methods for automatically obtaining the dimensions of a single reference object or multiple reference objects with different numbers of processed mark, so as to increase the accuracy of calculating any dimension of various photographed objects.

### SUMMARY OF THE INVENTION

The present invention is directed to providing a method of length measurement for 2d photography by calculating an area of a geometrical shape of a reference image of a reference object with a predetermined size. After a background image is separated from a reference image and the reference image is scanned on a screen to obtain a total number of pixels included in a range of the a reference image, the number of pixels corresponding to a unit length of the reference image can be obtained based on the predetermined size and an area formula of the geometrical shape. In contrast, after a measuring object is placed on the background and photographed in the same shooting distance, zoom of lens and shooting angle, a length of any two points of a measuring image of the measuring object can be obtained based on the number of pixels corresponding to the two points. The accuracy of measurement can be increased by aligning the camera with the centers of the reference object and the measuring object. Both of the predetermined size and the area formula of the reference object are necessary to be manually inputted.

Generally, it is recommended to use a reference object having a size close to the size of the measuring object to obtain a better accuracy of measurement. However, it is possible to obtain wrong size and/or wrong area formula of the reference object by manually inputting various sizes and area formulas for different reference objects, and thus result in measurement error to the measuring object. As a result, each of the reference objects provided in some embodiment of the present invention is also processed to have at least a processed mark formed thereon, and thus it is possible to not only increase the accuracy of selection for the reference object having a desired predetermined size, but also automatically obtain the size and the area formula of the reference object saved in the computer based on the number of the processed mark, so as to avoid the measurement error due to manual input.

The reference object of the present invention usually uses a flat plate or a column with a predetermined size, and the area calculation is based on a plane projection of the reference object, i.e. a plane geometrical shape projected by a contour of the reference object and able to be represented by an area formula. Indeed, the flat plate type of the thinner reference object is usually used for a thinner measuring object, and the column type of the reference object (such as a cylindrical or a triangular cylinder) having a thickness close to the measuring object is usually used for a thicker measuring object, so as to increase the measurement accuracy. Instead of the above-mentioned flat plates and columns, it is also possible to use a flat plate or a column with a top surface having a plurality of protrusions or blocks or balls thereon, and the geometrical shape is a plane projection defined by a contour of the reference object along a photographing direction of the camera. However, for a 3d photography with various shooting angles, the plane projection of the reference object is varied with the shooting angle and results in the variations of the predetermined size and the area formula, so that the flat plate type of the reference object is generally unsuitable for measuring a 3d measuring object from various shooting angles. As a result, the present invention is further directed to an application of using a ball with a single predetermined diameter as the reference object, so as to enable the plane projection of the reference object for measuring the measuring object from various shooting angles to be invariable.

Accordingly, the reference object can be a flat plate or a column having a geometrical shape with an area easy to be calculated, such as a square, a triangle, a rectangle, a trapezia, a lozenge, a circular, a star or a polygon as shown in FIG. 2, wherein a top surface thereof can be an even surface or have protrusions or blocks, and the geometrical shape is a plane projection defined by a contour of the reference object along a photographing direction of the camera, and the reference object can also be a ball in some embodiments, i.e. anything with a geometrical shape capable of being represented by an area formula can be a reference object for measurement. As shown in FIG. 2, the dimensions of the reference objects are respectively represented by a, b, d and h, and thus the area of a square is represented as a×a, that of a rectangle is represented as a×b, that of a triangle is represented as a×h/2, that of a trapezia is represented as (a+b)×h/2, that of a lozenge is represented as a×h, that of radial projection of a cylinder is represented as a×h, and that of a projection of a circle or a ball is represented as r×d×d/4, wherein d is the diameter, and π is the circumference ratio. In some other embodiments, each of the reference objects capable of being represented by an area formula with a predetermined size can also be processed to form a specific number of processed mark formed on the geometrical shape of the reference object, for example, there are one or more processed marks formed on a rectangle of the reference object as shown in FIG. 3, wherein the processed marks are isolated and can be any shape, such as a circular, a triangle, a square, a rectangle, a trapezia, a lozenge, a star, or a polygon and so on, and each of them can be a hole passing through the reference object or a label pasted on the reference object with a color obviously different to the reference object. Hence, it is possible to automatically obtain the predetermined size of the reference object based on the number of the processed mark as a reference for calculating the size of the measuring object on a screen since the look up table saved in a computer includes various number of the processed marks, various predetermined sizes and various area formulas corresponding to different geometrical shapes for various reference objects. Hence, this application can avoid not only the need to manually input the size of the selected reference object, but also the possibility of inputting wrong size of the reference object.

### BRIEF DESCRIPTION OF THE DRAWINGS

FIG. 1 illustrates a flow chart of a method of length measurement for 2d photography by calculating an area of a geometrical shape of a reference object with a predetermined size according to an embodiment of the present invention.

FIG. 2 represents some geometrical shapes of flat plate type, column type or ball type reference object used for the method of length measurement for 2d photography by calculating an area of a geometrical shape of a reference object with a predetermined size according to an embodiment of the present invention.

FIG. 3 represents some embodiments of the shape of processed mark.

FIG. 4 represents a placement of a reference object and a measuring object in the vertical photography used for the method of length measurement for 2d photography by calculating an area of a geometrical shape of a reference object with a predetermined size according to an embodiment of the present invention.

FIG. 5 represents a placement of a reference object and a measuring object in the horizontal photography used for the method of length measurement for 2d photography by calculating an area of a geometrical shape of a reference object with a predetermined size according to an embodiment of the present invention.

FIG. 6 represents the placements of the reference object having processed marks in the vertical photography and the horizontal photography with reference object hanging used for the method of length measurement for 2d photography by calculating an area of a geometrical shape of a reference object with a predetermined size according to an embodiment of the present invention.

FIG. 7 illustrates a flow chart of the method of length measurement for 2d photography by calculating an area of a geometrical shape of a reference object with a predetermined size according to an embodiment of the present invention, wherein there is at least a processed mark formed on the reference object.

FIG. 8 illustrates a flow chart for representing the details of the step S23 as shown in FIG. 7.

FIG. 9 illustrates a schematic view of hemispherical photography of a method of length measurement for 2d photography by calculating an area of a circular projection of a ball type reference object with a predetermined diameter according to an embodiment of the present invention.

FIG. 10 illustrates a schematic view of spherical photography of a method of length measurement for 2d photography by calculating an area of a circular projection of a ball type reference object with a predetermined diameter according to an embodiment of the present invention.

FIG. 11 illustrates a schematic view of the scanning steps as shown in FIG. 8.

FIG. 12 illustrates a schematic view for separating a background image from a high gray level form of a reference image.

### DETAILED DESCRIPTION OF THE INVENTION

The following descriptions accompanied with the drawings are only for facilitating to better understand the features, the intentions and the functions of the present invention and not for limiting the scope of the present invention.

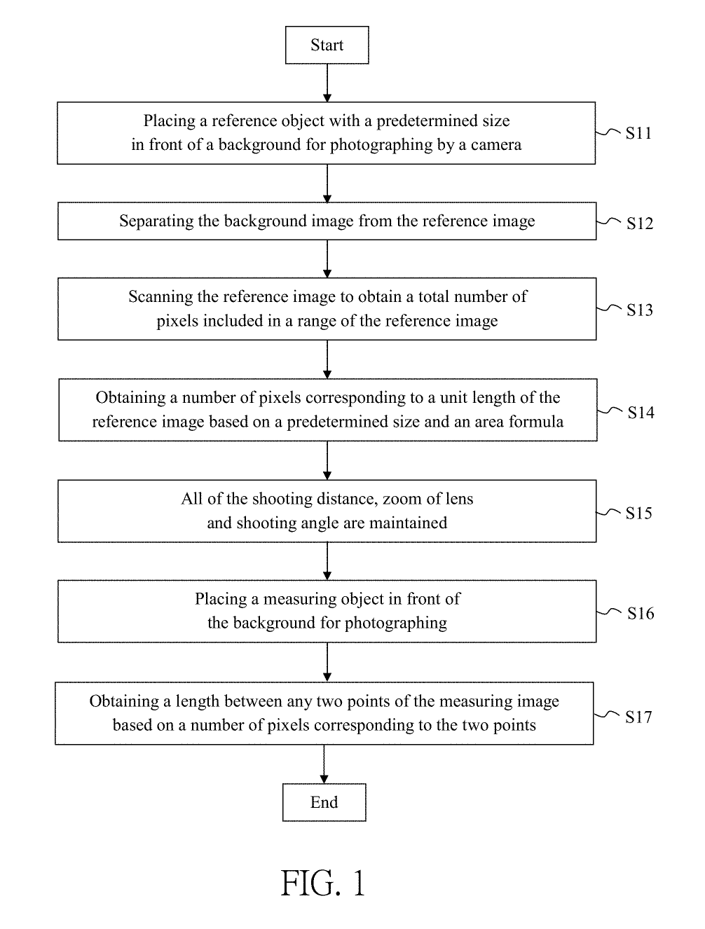

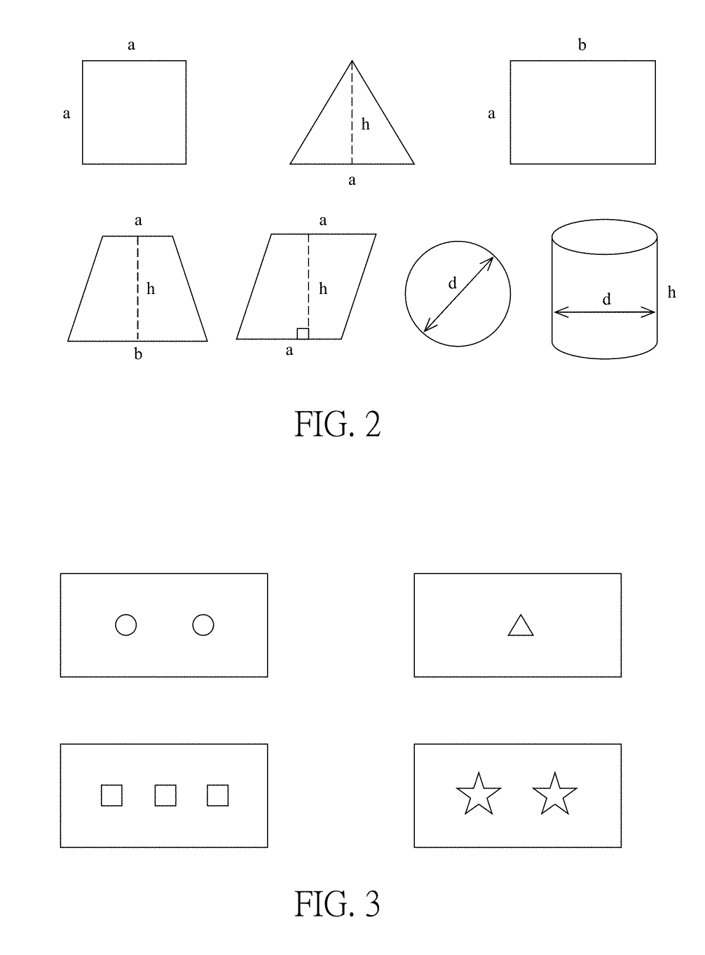

FIG. 1 illustrates a flow chart of a method of length measurement for 2d photography by calculating an area of a geometrical shape of a reference object with a predetermined size according to an embodiment of the present invention. The geometrical shape is a plane projection defined by a contour of the reference object along a photographing direction of the camera. The step S11 is selecting and placing a reference object with a predetermined size in front of a background for photographing by a camera, and then saving a reference image obtained therefrom into a computer. Thereafter, the step S12 is separating a background image from the reference image on a screen by the computer. Afterward, the step S13 is scanning the reference image by the computer to obtain a total number of pixels included in a range of the reference image, and then the step S14 is obtaining a first number of pixels corresponding to a unit length of the reference image based on a predetermined size and an area formula saved in the computer. All of the shooting distance, zoom of lens and shooting angle are maintained then as shown in the step S15. Next, the step S16 is placing a measuring object in front of the background for photographing by the camera, and then also saving a measuring image obtained therefrom into the computer. Hence, a length between any two points of the measuring image can be obtain based on a second number of pixels corresponding to the two points as shown in the step S17. However, there is no processed mark formed on the reference object as illustrated in FIG. 1, and thus it is necessary to reset the predetermined size and the area formula saved in the computer once the reference object is replaced by a different one. During the practice of the above-mentioned procedure, the measuring object can be photographed prior to the reference object for confirming the scope of the measuring object, i.e. the steps S15 and S16 can be operated prior to steps S11, S12, S13, S14 and S17. FIG. 2 represents some geometrical shapes of flat plate type, column type or ball type reference object used for the method of length measurement for 2d photography by calculating an area of a geometrical shape of a reference object with a predetermined size according to an embodiment of the present invention. The reference object can be anything with a geometrical shape capable of being represented by an area formula, such as a flat plate, a flat plate having at least a protrusion or block thereon, or a column or a ball. The range for calculating the total number of pixels of a ball type reference object is based on the circular projection along the photographing direction of the camera. A circular projection is formed by an around plate type or ball type reference object.

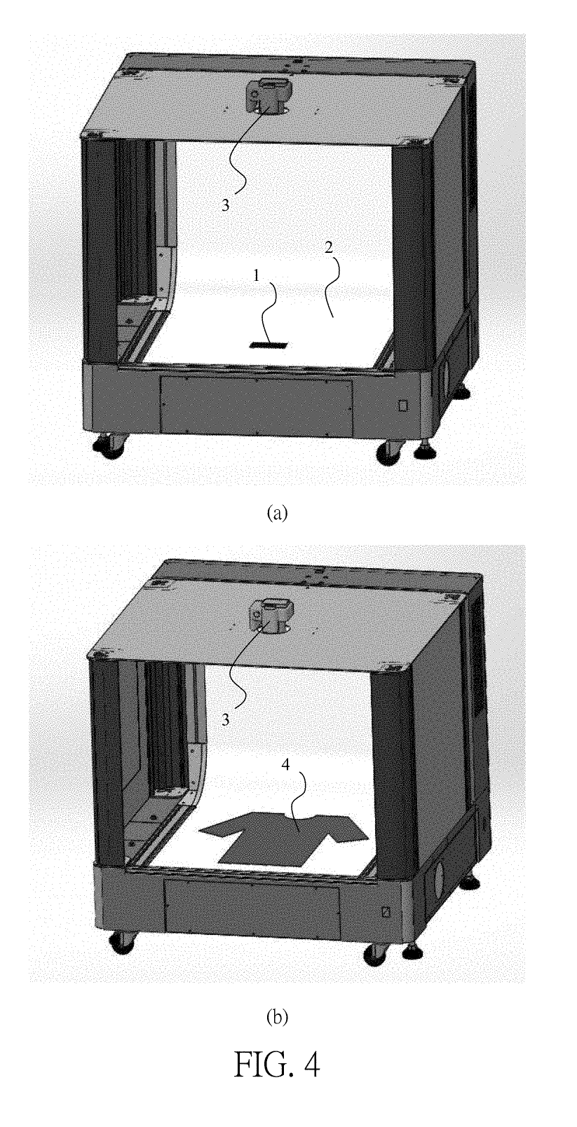

FIG. 4 represents a placement of a reference object and a measuring object in the vertical photography used for the method of length measurement for 2d photography by calculating an area of a geometrical shape of a reference object with a predetermined size according to an embodiment of the present invention. FIG. 4 (a) shows that a reference object 1 is horizontally placed on a background 2 and then photographed by a camera 3 vertically. In contrast, FIG. 4 (b) shows that the camera 3 aligns a measuring object 4 and then the measuring object 4 is vertically photographed and measured.

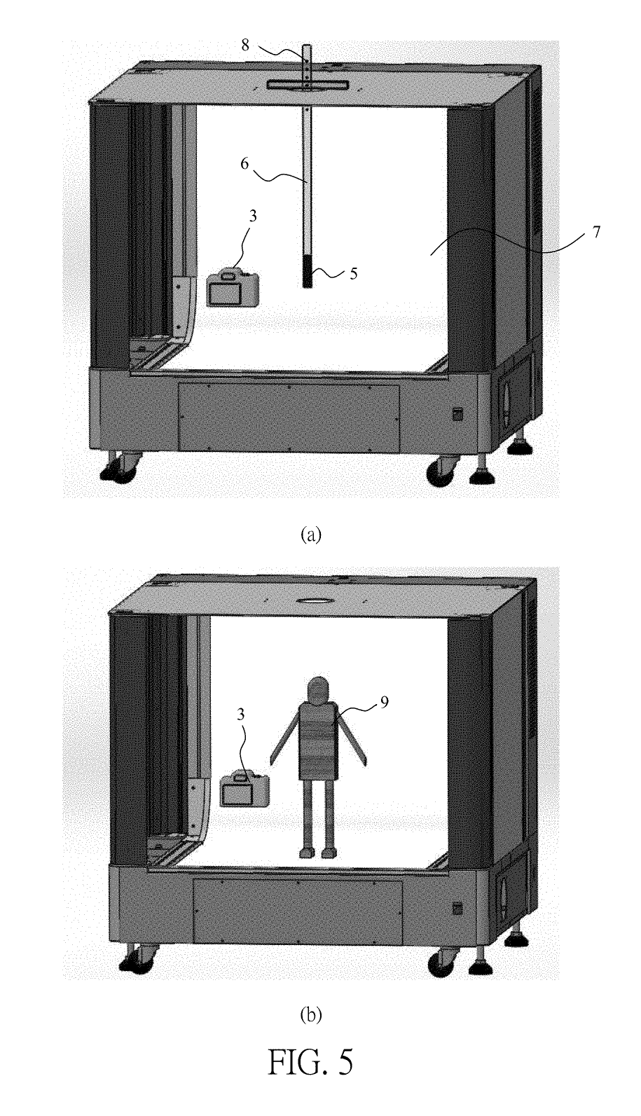

FIG. 5 represents a placement of a reference object and a measuring object in the horizontal photography used for the method of length measurement for 2d photography by calculating an area of a geometrical shape of a reference object with a predetermined size according to an embodiment of the present invention. FIG. 5 (a) shows that a reference object 5 is attached on a transparent acrylic bar 6 vertically hanged in front of a background 7 and then horizontally photographed by a camera 3, wherein an elevation of a middle point of the reference object 5 should be generally the same as that of a measuring object 9 desired to be measured, and there can further have a list of apertures 8 formed on the transparent acrylic bar 6 for adjusting the elevation of the middle point of the reference object 5. In contrast, FIG. 5 (b) shows that the camera 3 aligns the middle point of a measuring object 9 and then the measuring object 9 is horizontally photographed and measured.

There are three well-known approaches usually used for separating the background image from the reference image listed as below:
(1) The first approach is separating the background image from the reference image based on the brightness difference. The common color modes comprises RGB, YIQ, HSV, YUV, YCbCr and so on, and thus we simply describe the RGB color mode herein. R is the abbreviation of Red, G is the abbreviation of Green, B is the abbreviation of Blue, and the RGB color mode can be converted into the YIQ color mode as a high gray level image, wherein Y stands for luminance, while I and Q stands for inphase and quadrature representing two different tones.

$$[ \begin{matrix}Y \\ I \\ Q\end{matrix} ] = [ \begin{matrix}0.299 & 0.587 & 0.114 \\ 0.596 & - 0.274 & - 0.322 \\ 0.211 & - 0.523 & 0.312\end{matrix} ] [ \begin{matrix}R \\ G \\ B\end{matrix} ]$$

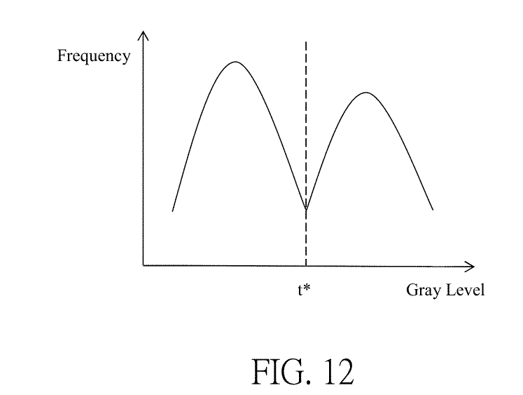

Thereafter, the high gray level image can further be binarized by brute-force based on a gap between the wave crest and the wave trough of a gray level distribution histogram as show in FIG. 12, wherein the pixels are respectively converted into black for a gray level value higher than t* and white for a gray level value lower than t*. Accordingly, the background image is separated from the reference image as shown in FIG. 12.
(2) The second approach is converting the RGB color mode into YCbCr color mode based on the chroma key first and then separating the background image from the reference image based on the feature values. The details of the chroma key can refer to the reference [1] Keith Jack, “Video Demystified”, Independent Pub Group (Computer), 1996. Chroma key is mainly used for movie, video and game related industries, which uses a green screen or a blue screen as a background, adjusts the color range of background, converts the color of background into transparent, and then replaces the background.
(3) The third approach is manually processing background removal on the computer and the screen for separating the background image from the reference image.

The step of scanning the reference image on a screen to obtain the total number of pixels included in a range of the reference image will be described together with the following description about processing one or more processed marks formed on the reference object. As illustrated in FIG. 1, the number of pixels corresponding to a unit length of the reference image can be obtained based on the predetermined size and the area formula of the reference object. In an example of using a rectangle as the reference object as shown in FIG. 2, the two side lengths are respectively represented as a and b, and the measure of area is a×b. When the total number of pixels included in a range of the reference image is obtained, the total number of pixels divided by the length b is equal to the number of pixels corresponding to the length a, and the number of pixels corresponding to the length a divided by length a is equal to the number of pixels corresponding to a unit length of the reference image. The symbols a, b, h, d represented for different geometrical shapes of the reference object as shown in FIG. 2 are all predetermined values, and thus the number of pixels corresponding to a unit length of any one of those reference objects for calculating the size of a measuring object can be obtained based on the above-mentioned calculation steps accompanied with different area formula and the total number of pixels included in a range of that reference image.

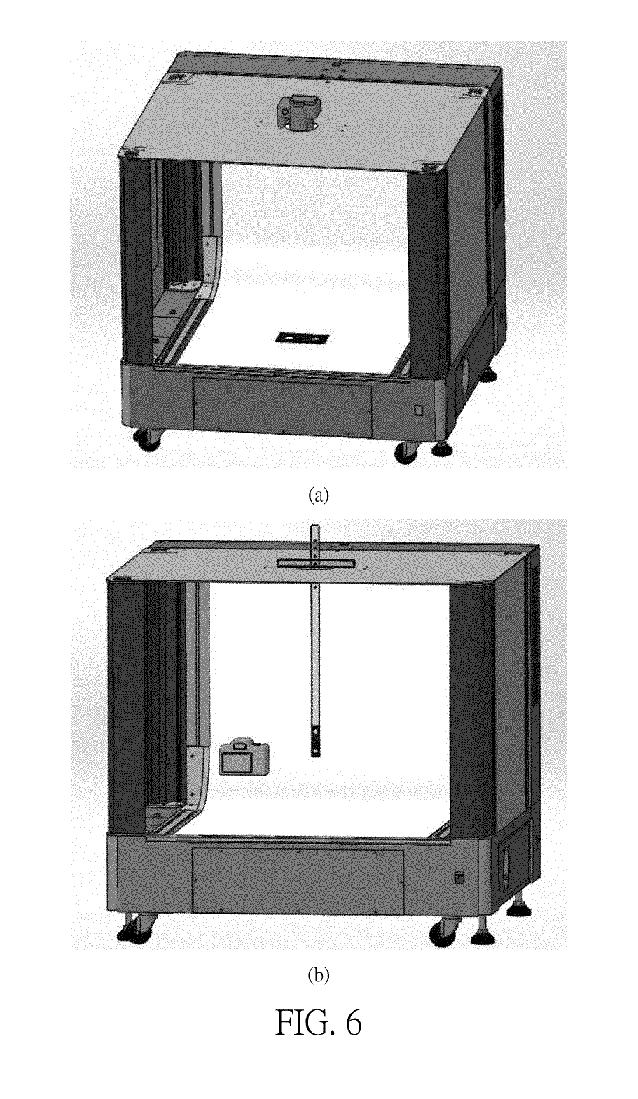

FIGS. 6 (a) & (b) respectively represent the placements of the reference object having processed marks in the vertical photography and the horizontal photography with reference object hanging used for the method of length measurement for 2d photography by calculating an area of a geometrical shape of a reference object with a predetermined size according to an embodiment of the present invention. The placement of the measuring object in the present embodiment is the same as those in the embodiments as shown in FIG. 4 (b) and FIG. 5 (b).

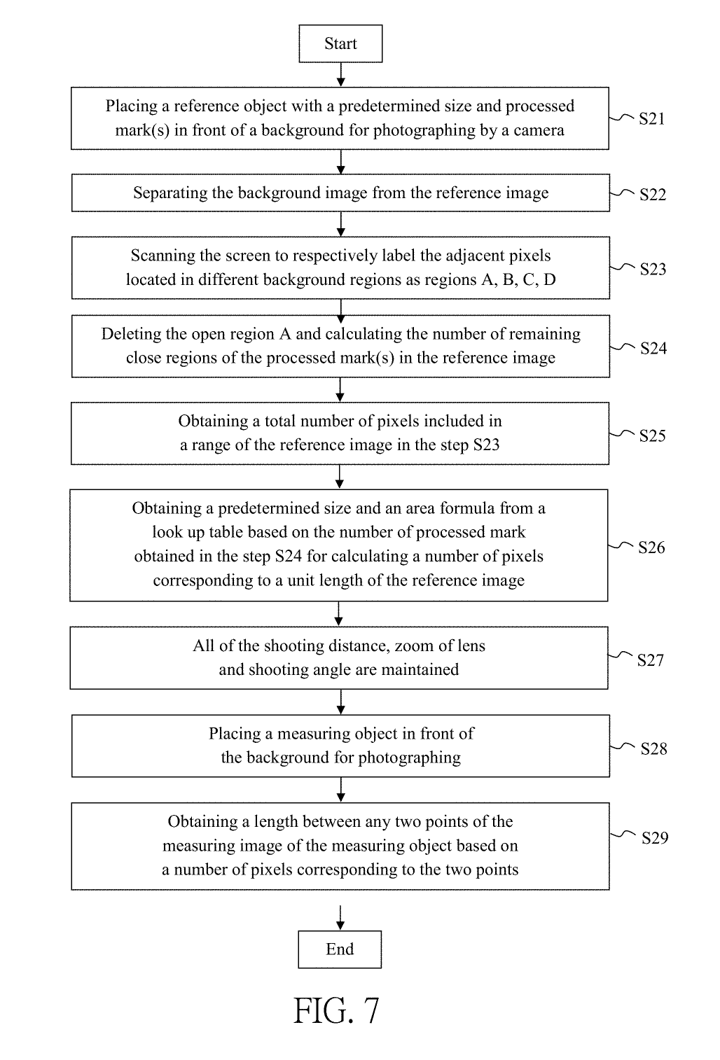

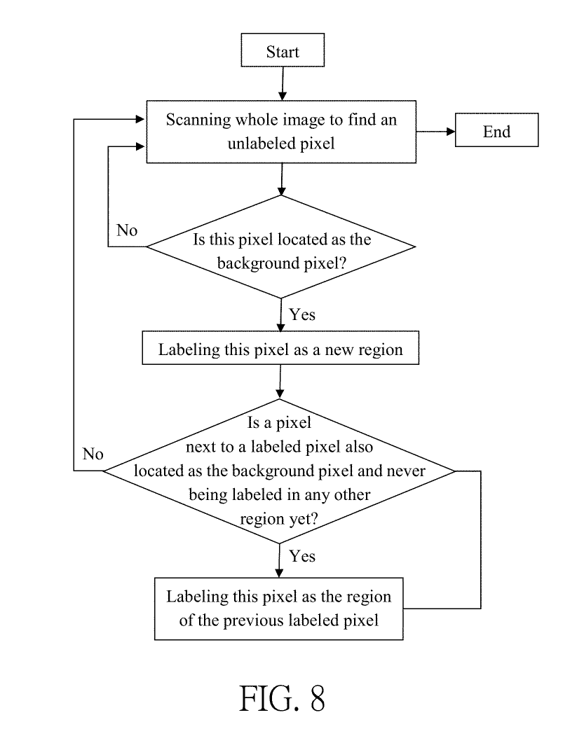

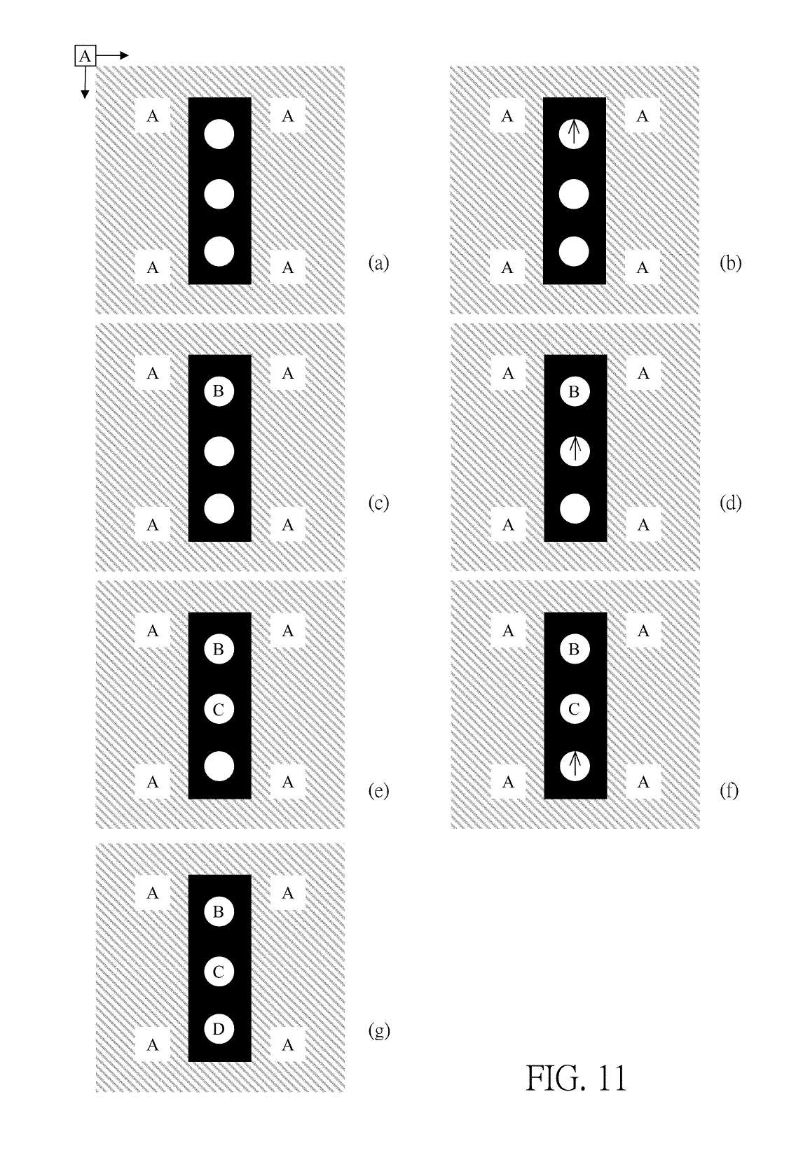

FIG. 7 illustrates a flow chart of the method of length measurement for 2d photography by calculating an area of a geometrical shape of a reference object with a predetermined size according to an embodiment of the present invention, wherein there is at least a processed mark formed on the reference object. FIG. 7 is similar to FIG. 1 except the details about the processed mark illustrated in the steps S21, S23-S26 of FIG. 7 are not disclosed in the steps S11, S13-S14 of FIG. 1, for example the steps S22, S27-S29 are totally the same as the steps S12, S15-S17 and thus are omitted herein. In a word, the function of the reference object as illustrated in FIG. 7 is similar to that as illustrated in FIG. 1 if there is only one processed mark. However, the method as illustrated in FIG. 7 can further be applied to some other embodiments, wherein a look up table saved in the computer contains a plurality of reference objects having different numbers of processed mark corresponding to different predetermined sizes, different geometrical shapes and/or different area formulas. It would not be wrong to obtain those parameters from the computer based on the different number of processed mark. Hence, it is possible to directly place a reference object having processed mark(s) with a size close to the size of the measuring object to be photographed once there are a plurality of measuring objects with different sizes. FIG. 8 illustrates a flow chart for representing the details of the step S23 as shown in FIG. 7, while FIG. 11 illustrates a schematic view of the scanning steps as shown in FIG. 8. FIG. 8 starts to scan the image of the reference object formed on the background and having the processed mark(s) from the upper left corner of the screen, and completes it from left to right and from top to bottom. The first pixel located in the background region is labeled as region A, and all pixels next to the pixel having the same background pixels are labeled as region A until no more pixel next to those pixels labeled as region A is located in the background region, such as the illustration of FIG. 11 (a).

Next, the unlabeled pixels are continuously searched, while the labeled pixels located in the background region will no more be searched. For example, another unlabeled pixel located in the background region will be searched at the top edge of the first processed mark as the illustration of FIG. 11 (b).

Then, similar to the step of labeling the first pixel as region A, the pixel searched in the previous step is labeled as region B, and all pixels next to the pixel having the same background pixels are labeled as region B until no more pixel next to those pixels labeled as region B is located in the background region, such as the illustration of FIG. 11 (c).

Next, the unlabeled pixels are continuously searched, while the labeled pixels located in the background region will no more be searched. For example, another unlabeled pixel located in the background region will be searched at the top edge of the second processed mark as the illustration of FIG. 11 (d).

Then, similar to the step of labeling the first pixel as region A, the pixel searched in the previous step is labeled as region C, and all pixels next to the pixel having the same background pixels are labeled as region C until no more pixel next to those pixels labeled as region C is located in the background region, such as the illustration of FIG. 11 (e).

Afterward, the steps for searching and labeling the pixels as region C are repeated to search and label the unlabeled pixels located in the third processed mark as region D as the illustration of FIG. 11 (f).

Thereafter, all of the regions A, B, C, D located in the background region are searched and labeled, wherein the open region A should be deleted and the three close regions B, C, D are remained as the illustration of FIG. 11 (g).

In a word, the region A outside the reference object and the regions B, C, D within the reference object can all be searched and labeled by a single scan, wherein all of the regions B, C, D should be included for calculating the total number of pixels included in the range of the reference image.

The step S26 in FIG. 7 is obtaining the predetermined size and the area formula from the look up table based on the number of processed mark obtained in the step S24, so as to calculate a number of pixels corresponding to a unit length of the reference image. The values of a, b, h corresponding to different numbers of processed mark can be preset closing to the size of the measuring object, as shown in the exemplary look up table, which can be filled in the corresponding area formula for calculation.

Look up table

| Number of | | | | Geometrical | |
|---|---|---|---|---|---|
| processed mark | a | b | h | shape | Area formula |
| 1 | 2 | 5 | | Rectangle | a × b |
| 2 | 4 | | 6 | Triangle | a × h/2 |
| 3 | 8 | 4 | 5 | Trapezia | (a + b) × h/2 |

The number of processed mark can be used for looking up not only the size of the reference object, but also the geometrical shape and the area formula thereof. In another word, different numbers of processed mark formed on different reference objects can be used for looking up different sizes, different geometrical shapes and different area formulas of different reference objects. Accordingly, as long as using a reference object with processed marks, the number of pixels corresponding to a unit length of the reference image can be automatically calculated by the computer. Herein, the processed marks s can be isolated holes or labels with any shape, such as a circular, a triangle, a square, a rectangle, a trapezia, a star or a polygon.

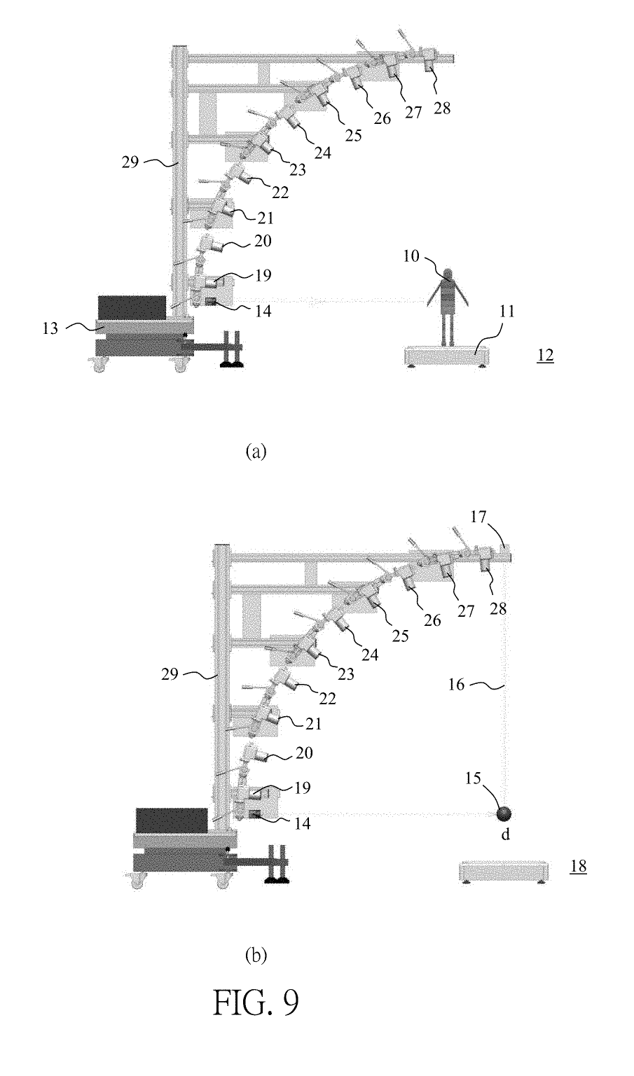

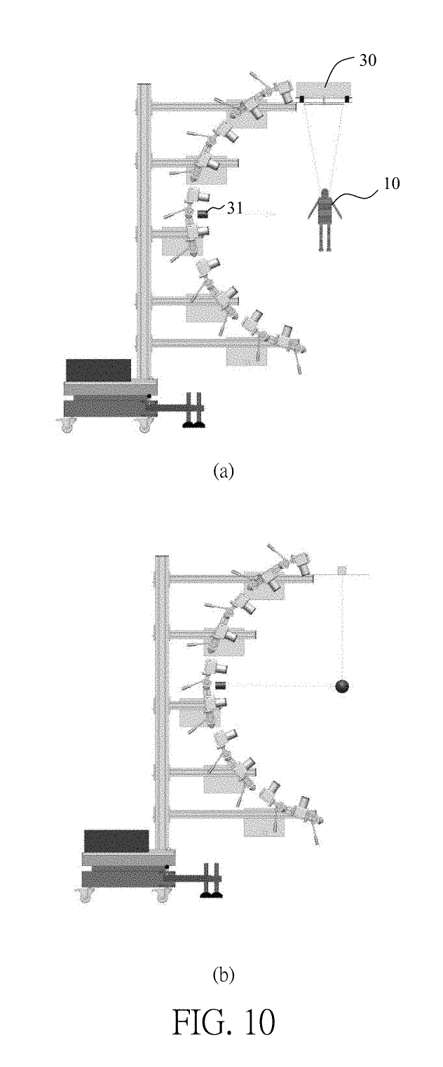

FIG. 9 illustrates a schematic view of hemispherical photography of a method of length measurement for 2d photography by calculating an area of a circular projection of a ball type reference object with a predetermined diameter according to an embodiment of the present invention. FIG. 9 (a) illustrates that a measuring object 10 is placed on a turntable 11 in front of a background 12, and an elevation of a hoist platform 13 is adjusted to align a laser pointer 14 on the hoist platform 13 with the center point of the measuring object 10. FIG. 9 (b) illustrates that a ball 15 with a predetermined diameter d is hanged under a holding block 17 with a transparent wire 16 or supported on a transparent pillar, and an elevation of the ball 15 is adjusted to align the center point thereof with a laser ray of the laser pointer 14. Thereafter, the ball 15 is photographed by a plurality of cameras 19-28 aiming the ball 15 and installed on multi-arms or an arc or circular rack, so as to obtain several circular projections by different cameras 19-28 for calculating the areas of the reference object from different shooting angles. Accordingly, it is possible to calculate a length of any two points of each image of the measuring object 10 from various shooting angles by photographing the measuring object 10 with those cameras 19-28 accompanied with rotating the measuring object 10 to various orientation by the turntable 11.

FIG. 10 illustrates a schematic view of spherical photography of a method of length measurement for 2d photography by calculating an area of a circular projection of a ball type reference object with a predetermined diameter according to an embodiment of the present invention. The photographing procedure as illustrated in FIG. 10 (a) & (b) is similar to that illustrated in FIG. 9 except the laser pointer 31 is fixed at a middle elevation and the turntable 30 is located at the upper side for bringing the measuring object 10 hanged under there to rotate for spherical photography.

In summary, the traditional way is taking a picture of an object accompanied with a ruler and manually input the length, and thus it is possible to result in measurement error. In addition, it also necessary to repeat the procedure several times for measuring the measuring objects with different sizes. In contrast, the present invention provides the method of length measurement for 2d photography by calculating an area of a geometrical shape of a reference object with a predetermined size, which can overcome all of the disadvantages. In addition, the present invention can also previously processing different numbers of processed marks on different reference objects and input the related parameters in the computer, and thus for measuring several measuring objects with different sizes, it is possible to obtain the number of pixels corresponding to a unit length of the reference object automatically once placing different numbers of reference objects for photographing.

Besides, all of the foregoing embodiments exemplarily illustrates photographing the reference object prior to the measuring object. However, a person having ordinary skill in the art can recognize that photographing the measuring object prior to the reference object in the same shooting distance, zoom of lens and shooting angle can also achieve the benefit of the present invention, even can ensure the measuring object located within a shooting range of the camera during photographing. In another word, the steps S16 can be exchanged with the steps S11-S14 for FIG. 1, while the steps S28 can be exchanged with the steps S21-S26 in FIG. 7. Accordingly, the embodiment of photographing the measuring object prior to the reference object should be included in the claimed scope of the present invention as well.

The method of length measurement for 2d photography of the present invention comprises, but is not limited to, the following two kinds of procedures:
1. placing a reference object in front of a background, wherein the reference object has a geometrical shape capable of being represented by an area formula with a predetermined size, and both of the predetermined size and the area formula are saved in a computer; photographing the reference object and the background by a camera to form a reference image; saving the reference image in the computer and displaying the reference image on a screen of the computer; separating a background image from the reference image, and displaying the reference image on the screen; scanning the reference image by using the computer to obtain a total number of pixels included in a range of the reference image, and obtaining a first number of pixels corresponding to a unit length of the reference image based on the predetermined size and the area formula; placing a measuring object in front of the background, photographing the measuring object and the background by the camera to form a measuring image, and saving the measuring image in the computer; and displaying the measuring image on the screen and clicking any two point of the measuring image, wherein a ratio of an actual length between the two points to the unit length is substantially equal to a ratio of a second number of pixels corresponding to the two points to the first number of pixels corresponding to unit length.
2. placing a reference object in front of a background, wherein the reference object has a geometrical shape capable of being represented by an area formula with a predetermined size, at least a processed mark is formed on the reference object, and a look up table containing a relationship among the predetermined size, the area formula and a number of the processed mark is saved in a computer; photographing the reference object and the background by a camera to form a reference image; saving the reference image in the computer and displaying the reference image on a screen of the computer; separating a background image from the reference image, and displaying the reference image on the screen; scanning the reference image by using the computer to obtain a total number of pixels included in a range of the reference image, marking and calculating the number of the processed mark on the reference image for obtaining the predetermined size based on the look up table, and obtaining a first number of pixels corresponding to a unit length of the reference image based on the predetermined size and the area formula; placing a measuring object in front of the background, photographing the measuring object and the background by the camera to form a measuring image, and saving the measuring image in the computer; and displaying the measuring image on the screen and clicking any two point of the measuring image, wherein a ratio of an actual length between the two points to the unit length is substantially equal to a ratio of a second number of pixels corresponding to the two points to the first number of pixels corresponding to unit length.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A method of length measurement for 2d photography, comprising:
placing a reference object in front of a background, wherein the reference object has a geometrical shape capable of being represented by an area formula with a predetermined size, and both of the predetermined size and the area formula are saved in a computer;
photographing the reference object and the background by a camera to form a reference image;
saving the reference image in the computer and displaying the reference image on a screen of the computer;
separating a background image from the reference image, and displaying the reference image on the screen;
scanning the reference image by using the computer to obtain a total number of pixels included in a range of the reference image, and obtaining a first number of pixels corresponding to a unit length of the reference image based on the predetermined size and the area formula;
placing a measuring object in front of the background, photographing the measuring object and the background by the camera to form a measuring image, and saving the measuring image in the computer; and
displaying the measuring image on the screen and clicking any two point of the measuring image, wherein a ratio of an actual length between the two points to the unit length is substantially equal to a ratio of a second number of pixels corresponding to the two points to the first number of pixels corresponding to unit length.

2. The method of length measurement for 2d photography as claimed in claim 1, wherein the reference object is a flat plate with a top surface thereof is an even surface or has at least one of a protrusion or a block, or a column and the geometrical shape is a plane projection defined by a contour of the reference object along a photographing direction of the camera and is a triangle, a square, a rectangle, a trapezia, a lozenge, a circular, a star or a polygon.

3. The method of length measurement for 2d photography as claimed in claim 1, wherein separating the background image from the reference image is based on brightness difference between the reference object and the background, feature value of the chroma key or manual background removal.

4. The method of length measurement for 2d photography as claimed in claim 1, wherein the reference object is placed in horizontal or hanged in vertical.

5. The method of length measurement for 2d photography as claimed in claim 2, wherein the reference object is a ball, and the camera takes photos from a plurality of shooting angles for a hemispherical photography or a spherical photography, so as to enable the measuring object to be measure from the shooting angles.

6. The method of length measurement for 2d photography as claimed in claim 5, wherein the ball is hanging downward or supported upward by a transparent pillar.

7. A method of length measurement for 2d photography, comprising:
placing a reference object in front of a background, wherein the reference object has a geometrical shape capable of being represented by an area formula with a predetermined size, at least a processed mark is formed on the reference object, and a look up table containing a relationship among the predetermined size, the area formula and a number of the processed mark is saved in a computer;
photographing the reference object and the background by a camera to form a reference image;
saving the reference image in the computer and displaying the reference image on a screen of the computer;
separating a background image from the reference image, and displaying the reference image on the screen;
scanning the reference image by using the computer to obtain a total number of pixels included in a range of the reference image, marking and calculating the number of the processed mark on the reference image for obtaining the predetermined size based on the look up table, and obtaining a first number of pixels corresponding to a unit length of the reference image based on the predetermined size and the area formula;
placing a measuring object in front of the background, photographing the measuring object and the background by the camera to form a measuring image, and saving the measuring image in the computer; and
displaying the measuring image on the screen and clicking any two point of the measuring image, wherein a ratio of an actual length between the two points to the unit length is substantially equal to a ratio of a second number of pixels corresponding to the two points to the first number of pixels corresponding to unit length.

8. The method of length measurement for 2d photography as claimed in claim 7, wherein the processed mark is a hole passing through the reference object or a label pasted on the reference object with a color obviously different to the reference object, and a shape of the processed mark is a circular, a triangle, a square, a rectangle, a trapezia, a lozenge, a star or a polygon.

9. The method of length measurement for 2d photography as claimed in claim 7, wherein separating the background image from the reference image is based on brightness difference between the reference object and the background, feature value of the chroma key or manual background removal.

10. The method of length measurement for 2d photography as claimed in claim 7, wherein the reference object is placed in horizontal or hanged in vertical.

11. The method of length measurement for 2d photography as claimed in claim 7, wherein a number of the reference object is plural, and the reference objects have different numbers of processed mark corresponding to different predetermined sizes, different geometrical shapes and different area formulas contained in the look up table.

12. The method of length measurement for 2d photography as claimed in claim 7, wherein the reference object is a flat plate with a top surface thereof is an even surface or has at least one of a protrusion or a block, or a column and the geometrical shape is a plane projection defined by a contour of the reference object along a photographing direction of the camera and is a triangle, a square, a rectangle, a trapezia, a lozenge, a circular, a star or a polygon.
